(19) United States
(12) Patent Application Publication
(10) Pub. No.: US 2024/0187827 A1
(43) Pub. Date: Jun. 6, 2024

(54) METHODS, APPARATUSES, AND COMPUTER READABLE MEDIA FOR CHARGING IN TELECOMMUNICATION NETWORK

(71) Applicant: NOKIA SOLUTIONS AND NETWORKS OY, Espoo (FI)

(72) Inventors: Xiangyang LI, Beijing (CN); Maryse GARDELLA, Velizy-Villacoublay (FR)

(21) Appl. No.: 18/556,187

(22) PCT Filed: Apr. 27, 2021
(86) PCT No.: PCT/CN2021/090120

§ 371 Date: Oct. 19, 2023

(51) Int. Cl. H04W 4/24; H04L 12/14; H04W 48/16

(52) U.S. Cl. CPC H04W 4/24; H04L 12/1407; H04W 48/16

(57) ABSTRACT

Disclosed are methods, apparatuses, and computer readable media for charging in a telecommunication network. An example method may include transmitting, a charging service request from a first network apparatus related to a user equipment converged charging system to a second network apparatus related to a tenant converged charging system, the charging service request comprising an indication for at least one parameter related to network slice level charging information of a network slice, an identifier of the network slice and an identifier of a user equipment; receiving, at the first network apparatus, a charging service response corresponding to the charging service request from the second network apparatus, the charging service response comprising the at least one parameter related to the network slice level charging information; and determining, by the first network apparatus, a charging criterion of the user equipment based on the received charging service response.

### TECHNICAL FIELD

Various embodiments relate to methods, apparatuses, and computer readable media for charging in a telecommunication network.

### BACKGROUND

In a telecommunication network such as a new radio (NR) system, a customer for example a tenant subscriber (hereinafter briefly referred as to “tenant”) may request a network operator to establish a network slice which is allocated with resources and capabilities to make the network appear as dedicated for the customer. A user equipment (UE) subscriber (hereinafter briefly referred as to “UE”) using services under the network slice needs to be charged.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is a method. The method may include transmitting, a charging service request from a first network apparatus related to a user equipment converged charging system to a second network apparatus related to a tenant converged charging system, receiving, at the first network apparatus, a charging service response corresponding to the charging service request from the second network apparatus, and determining, by the first network apparatus, a charging criterion of the user equipment based on the received charging service response. The charging service request may include an indication for at least one parameter related to network slice level charging information of a network slice, an identifier of the network slice and an identifier of a user equipment, and the charging service response may include the at least one parameter related to the network slice level charging information.

In some embodiments, the method may further include determining the second network apparatus based on the identifier of the network slice received by the first network apparatus in a request for charging the user equipment.

In some embodiments, the second network apparatus may be determined by querying a network repository function containing an association between the identifier of the network slice and the second network apparatus.

In some embodiments, the at least one parameter related to the network slice level charging information in the charging service response comprises at least one of a maximum number of protocol data unit session, a maximum number of user equipment, a number of ongoing protocol data unit session, a number of registered user equipment, a load level, or a volume.

In some embodiments, the charging service response may include information of at least one of: at least one allowed network slice and at least one rejected network slice.

In a second aspect, disclosed is a method. The method may include receiving, at a first network apparatus related to a tenant converged charging system, a charging service request from a second network apparatus related to a user equipment converged charging system, determining, at the first network apparatus, a charging service response based on the charging service request, and transmitting the charging service response from the first network apparatus to the second network apparatus. The charging service request may include an indication for at least one parameter related to network slice level charging information of a network slice, an identifier of the network slice and an identifier of a user equipment, and the charging service response may include the at least one parameter related to the network slice level charging information.

In some embodiments, the charging service response may be determined by determining the network slice level charging information based on the identifier of the network slice, and determining the at least one parameter related to the network slice level charging information in the charging service response based on the indication for the at least one parameter related to the network slice level charging information.

In some embodiments, the at least one parameter related to the network slice level charging information in the charging service response may include at least one of a maximum number of protocol data unit session, a maximum number of user equipment, a number of ongoing protocol data unit session, a number of registered user equipment, a load level, or a volume.

In some embodiments, the determining the charging service response may further include determining the network slice is allowed or rejected for the user equipment based on at least one of the identifier of the user equipment, the identifier of the network slice, or the network slice level charging information.

In some embodiments, the charging service response comprises information of at least one of: at least one allowed network slice or at least one rejected network slice.

In a third aspect, disclosed is an apparatus. The apparatus may include at least one processor and at least one memory. The at least one memory may include computer program code, the at least one memory and the computer program code being configured to, with the at least one processor, cause the apparatus as a first network apparatus related to a user equipment converged charging system to perform transmitting a charging service request to a second network apparatus related to a tenant converged charging system, receiving a charging service response corresponding to the charging service request from the second network apparatus, and determining a charging criterion of the user equipment based on the received charging service response. The charging service request may include an indication for at least one parameter related to network slice level charging information of a network slice, an identifier of the network slice and an identifier of a user equipment, and the charging service response may include the at least one parameter related to the network slice level charging information.

In some embodiments, the at least one memory and the computer program code may be further configured to, with the at least one processor, cause the apparatus to further perform determining the second network apparatus based on the identifier of the network slice received in a request for charging the user equipment.

In some embodiments, the second network apparatus may be determined by querying a network repository function containing an association between the identifier of the network slice and the second network apparatus.

In some embodiments, the at least one parameter related to the network slice level charging information in the charging service response may include at least one of a maximum number of protocol data unit session, a maximum number of user equipment, a number of ongoing protocol data unit session, a number of registered user equipment, a load level, or a volume.

In some embodiments, the charging service response may include information of at least one of: at least one allowed network slice and at least one rejected network slice.

In a fourth aspect, disclosed is an apparatus. The apparatus may include at least one processor and at least one memory. The at least one memory may include computer program code, the at least one memory and the computer program code being configured to, with the at least one processor, cause the apparatus as a first network apparatus related to a tenant converged charging system to perform receiving a charging service request from a second network apparatus related to a user equipment converged charging system, determining a charging service response based on the charging service request, and transmitting the charging service response to the second network apparatus. The charging service request may include an indication for at least one parameter related to network slice level charging information of a network slice, an identifier of the network slice and an identifier of a user equipment, and the charging service response may include the at least one parameter related to the network slice level charging information.

In some embodiments, the charging service response may be determined by determining the network slice level charging information based on the identifier of the network slice, and determining the at least one parameter related to the network slice level charging information in the charging service response based on the indication for the at least one parameter related to the network slice level charging information.

In some embodiments, the at least one parameter related to the network slice level charging information in the charging service response may include at least one of a maximum number of protocol data unit session, a maximum number of user equipment, a number of ongoing protocol data unit session, a number of registered user equipment, a load level, or a volume.

In some embodiments, determining the charging service response may further include determining the network slice is allowed or rejected for the user equipment based on at least one of the identifier of the user equipment, the identifier of the network slice, or the network slice level charging information.

In some embodiments, the charging service response may include information of at least one of: at least one allowed network slice or at least one rejected network slice.

In a fifth aspect, disclosed is an apparatus. The apparatus as a first network apparatus related to a user equipment converged charging system may include means for transmitting a charging service request to a second network apparatus related to a tenant converged charging system, means for receiving a charging service response corresponding to the charging service request from the second network apparatus, and means for determining a charging criterion of the user equipment based on the received charging service response. The charging service request may include an indication for at least one parameter related to network slice level charging information of a network slice, an identifier of the network slice and an identifier of a user equipment, and the charging service response may include the at least one parameter related to the network slice level charging information.

In some embodiments, the apparatus may further include means for determining the second network apparatus based on the identifier of the network slice received in a request for charging the user equipment.

In some embodiments, the second network apparatus may be determined by querying a network repository function containing an association between the identifier of the network slice and the second network apparatus.

In some embodiments, the at least one parameter related to the network slice level charging information in the charging service response may include at least one of a maximum number of protocol data unit session, a maximum number of user equipment, a number of ongoing protocol data unit session, a number of registered user equipment, a load level, or a volume.

In some embodiments, the charging service response may include information of at least one of: at least one allowed network slice and at least one rejected network slice.

In a sixth aspect, disclosed is an apparatus. The apparatus as a first network apparatus related to a tenant converged charging system may include means for receiving a charging service request from a second network apparatus related to a user equipment converged charging system, means for determining a charging service response based on the charging service request, and means for transmitting the charging service response to the second network apparatus. The charging service request may include an indication for at least one parameter related to network slice level charging information of a network slice, an identifier of the network slice and an identifier of a user equipment, and the charging service response may include the at least one parameter related to the network slice level charging information.

In some embodiments, the charging service response may be determined by determining the network slice level charging information based on the identifier of the network slice, and determining the at least one parameter related to the network slice level charging information in the charging service response based on the indication for the at least one parameter related to the network slice level charging information.

In some embodiments, the at least one parameter related to the network slice level charging information in the charging service response may include at least one of a maximum number of protocol data unit session, a maximum number of user equipment, a number of ongoing protocol data unit session, a number of registered user equipment, a load level, or a volume.

In some embodiments, the means for determining the charging service response may further include means for determining the network slice is allowed or rejected for the user equipment based on at least one of the identifier of the user equipment, the identifier of the network slice, or the network slice level charging information.

In some embodiments, the charging service response may include information of at least one of: at least one allowed network slice or at least one rejected network slice.

In a seventh aspect, a computer readable medium is disclosed. The computer readable medium may include program instructions stored thereon for causing an apparatus as a first network apparatus related to a user equipment converged charging system to perform transmitting a charging service request to a second network apparatus related to a tenant converged charging system, receiving a charging service response corresponding to the charging service request from the second network apparatus, and determining a charging criterion of the user equipment based on the received charging service response. The charging service request may include an indication for at least one parameter related to network slice level charging information of a network slice, an identifier of the network slice and an identifier of a user equipment, and the charging service response may include the at least one parameter related to the network slice level charging information.

In some embodiments, the computer readable medium may further include program instructions stored thereon for causing the apparatus to further perform determining the second network apparatus based on the identifier of the network slice received in a request for charging the user equipment.

In some embodiments, the second network apparatus may be determined by querying a network repository function containing an association between the identifier of the network slice and the second network apparatus.

In some embodiments, the at least one parameter related to the network slice level charging information in the charging service response may include at least one of a maximum number of protocol data unit session, a maximum number of user equipment, a number of ongoing protocol data unit session, a number of registered user equipment, a load level, or a volume.

In some embodiments, the charging service response may include information of at least one of: at least one allowed network slice and at least one rejected network slice.

In an eighth aspect, a computer readable medium is disclosed. The computer readable medium may include program instructions stored thereon for causing an apparatus as a first network apparatus related to a user equipment converged charging system to perform receiving a charging service request from a second network apparatus related to a user equipment converged charging system, determining a charging service response based on the charging service request, and transmitting the charging service response to the second network apparatus. The charging service request may include an indication for at least one parameter related to network slice level charging information of a network slice, an identifier of the network slice and an identifier of a user equipment, and the charging service response may include the at least one parameter related to the network slice level charging information.

In some embodiments, the charging service response may be determined by determining the network slice level charging information based on the identifier of the network slice, and determining the at least one parameter related to the network slice level charging information in the charging service response based on the indication for the at least one parameter related to the network slice level charging information.

In some embodiments, the at least one parameter related to the network slice level charging information in the charging service response may include at least one of a maximum number of protocol data unit session, a maximum number of user equipment, a number of ongoing protocol data unit session, a number of registered user equipment, a load level, or a volume.

In some embodiments, the determining the charging service response may further include determining the network slice is allowed or rejected for the user equipment based on at least one of the identifier of the user equipment, the identifier of the network slice, or the network slice level charging information.

In some embodiments, the charging service response may include information of at least one of: at least one allowed network slice or at least one rejected network slice.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows an exemplary sequence chart of charging in a telecommunication network according to an embodiment of the present disclosure.

FIG. 2 shows a distributed charging architecture in which example embodiments of the present disclosure can be implemented.

FIG. 3 shows a distributed charging architecture in which example embodiments of the present disclosure can be implemented.

FIG. 4 shows a correspondence between network slices and tenant CCSs in the distributed charging architecture depicted by the FIG. 3.

FIG. 5 shows a distributed charging architecture in which example embodiments of the present disclosure can be implemented.

FIG. 6 shows an example of determination of parameters related to network slice level charging information of a network slice according to an embodiment of the present disclosure.

FIG. 7 shows an example flow of charging in a telecommunication network according to an embodiment of the present disclosure.

FIG. 8 shows an example flow of charging in a telecommunication network according to an embodiment of the present disclosure.

FIG. 9 shows an example flow of charging in a telecommunication network according to an embodiment of the present disclosure.

FIG. 10 shows a flow chart illustrating an example method for charging in a telecommunication network according to an embodiment of the present disclosure.

FIG. 11 shows a flow chart illustrating an example method for charging in a telecommunication network according to an embodiment of the present disclosure.

FIG. 12 shows a block diagram illustrating an apparatus for charging in a telecommunication network according to an embodiment of the present disclosure.

FIG. 13 shows a block diagram illustrating an apparatus for charging in a telecommunication network according to an embodiment of the present disclosure.

FIG. 14 shows a block diagram illustrating an apparatus for charging in a telecommunication network according to an embodiment of the present disclosure.

FIG. 15 shows a block diagram illustrating an apparatus for charging in a telecommunication network according to an embodiment of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

Network slice level charging information, e.g. network slice management charging data, network slice performance and analytics charging data, may reflect how the virtual network slice utilizes the physical network resource, for example, a network slice with 50000 registered UEs will probably consume far more network resource than a network slice with 500 registered UEs. So the charging of the UE related to services used under the network slice may be influenced by for example network slice management and/or performance and analytics data. However, currently, UE related charging is handled separately from network slice related charging, for example, there is no way in current charging solution to charge UE based on the network slice level charging information, that is, current UE charging is done without considering network slice level information

An online and offline converged charging system (CCS) performing charging functionalities for an individual UE may be referred as to a UE CCS, and a CCS performing charging functionalities for a tenant may be referred as to a tenant CCS. The CCS may relate to a network apparatus which supports charging service, and such network apparatus may for example function as a charging function (CHF) inside the CCS to support the charging service. The CHF and the CCS will be collectively herein referred as to “CCS”.

In a distributed charging architecture for the telecommunication network, the UE CCS and the tenant CCS may communicate for charging the UE based on the serving network slice owned by the tenant. The UE may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like.

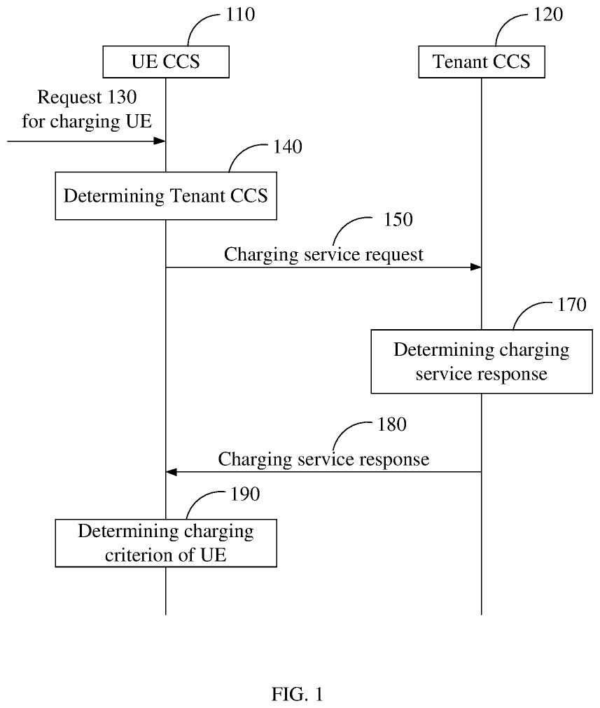

FIG. 1 shows an exemplary sequence chart of charging in a telecommunication network according to an embodiment of the present disclosure. Referring to FIG. 1, a UE CCS 110 may represent a UE CCS instance and relate to a network apparatus to support the charging of the UE. The charging of the UE may relate to for example at least one of UE protocol data unit (PDU) data connectivity, internet protocol (IP) multimedia subsystem (IMS) charging, short message service (SMS) charging, or etc. A tenant CCS 120 may represent a tenant CCS instance for maintaining and handling network slice level charging information of the network slice owned by the tenant and relate to a network apparatus to support the network slice level charging.

The UE CCS 110 may receive a request 130 for charging the UE. The request 130 for charging the UE may be transmitted from a consumer network function e.g. an access and mobility management function (AMF), a session management function (SMF), etc., and may include a single network slice selection assistance information (S-NSSAI) identifier, which may be an identifier of the network slice e.g. serving the UE and to be considered for charging of the UE.

In an operation 140, the UE CCS 110 may determine the tenant CCS 120 maintaining the network slice level charging information which may be utilized for the charging of the UE based on the identifier of the network slice in the received request 130.

In an embodiment, the UE CCS 110 may determine the tenant CCS 120 based on a local association between the identifier of the network slice and the tenant CCS 120. In order to determine an address of the tenant CCS 120, for example, the UE CCS 110 may query an internal mapping table associating the S-NSSAI identifier with the tenant CCS 120. For example, the UE CCS 110 may be locally pre-configured with the internal mapping table. Additionally or alternatively, the UE CCS 110 may broadcast a self-learning request to a plurality of tenant CCS instances to determine the tenant CCS 120 which serves the tenant owning the network slice with the S-NSSAI identifier.

Additionally or alternatively, the UE CCS 110 may determine the second network apparatus by querying a network repository function (NRF) containing an association between the identifier of the network slice and the tenant CCS 120. For example, the UE CCS 110 may transmit a network function (NF) discovery message with the identifier of the network slice to the NRF and the NRF may return the address of the tenant CCS 120 based on the association between the identifier of the network slice and the tenant CCS 120, so that the UE CCS 110 may discover the address of the tenant CCS 120.

In a case where the UE is to be charged dependent on the network slice level charging information of the network slice, the UE CCS 110 may transmit to the tenant CCS 120 a charging service request 150 to obtain the network slice level charging information for charging the UE.

In an embodiment, the charging service request 150 may include, for example, an indication for at least one parameter related to network slice level charging information of a network slice, an identifier of the network slice and an identifier of a user equipment.

The identifier of the UE may indicate the UE to be charged. The identifier of the network slice may indicate the network slice serving the UE and to be considered for charging of the UE. The identifier of the UE and the identifier of the network slice may be elements of UE level charging information, which may be e.g. UE PDU session charging information, UE registration charging information, etc.

The indication for at least one parameter related to network slice level charging information of a network slice may indicate the at least one parameter related to the network slice level charging information to be acquired from the tenant CCS 120. For example, among the parameters related to the network slice level charging information maintained in the tenant CCS 120 such as a maximum number of PDU session, a maximum number of UEs, a number of ongoing PDU session, a number of registered UEs, a load level, a volume, a duration, etc., the indication may indicate the at least one parameter used for charging the UE, which may depend on e.g. a charging plan of the UE. For example, if the UE is to be charged based on the load level of the network slice, the indication may indicate to acquire the load level of the network slice as the parameter.

Receiving the charging service request 150, in an operation 170 the tenant CCS 120 may determine a charging service response 180 based on the charging service request 150, and the charging service response 180 may include the at least one parameter related to the network slice level charging information.

The network slice level charging information maintained in the tenant CCS 120 may include e.g. at least one of network slice management (NSM) charging data or network slice performance and analytics (NSPA) charging data with respect to the network slice.

The NSM charging data may include e.g. an identifier of the tenant and the identifier of the network slice as well as at least one parameter related to the NSM charging data, such as the maximum number of PDU session, the maximum number of UEs, etc. of the network slice.

The NSPA charging data may include e.g. an identifier of the tenant and the identifier of the network slice as well as at least one parameter related to the NSPA charging data, such as the number of ongoing PDU session, the number of registered UEs, the load level, the volume or the duration, etc. of the network slice.

Thus, based on the identifier of the network slice in the charging service request 150, the tenant CCS 120 may determine the corresponding network slice level charging information.

Optionally, the tenant CCS 120 may determine the identifier of the tenant based on an association between the identifier of the network slice and the identifier of the tenant. For example, the tenant CCS 120 may maintain a correspondence between the identifier of the S-NSSAI and the identifier of the tenant owning the network slice, and thus may determine the identifier of the tenant from the identifier of the network slice in the charging service request 150. Then, the tenant CCS 120 may determine the corresponding network slice level charging information based on the identifier of the network slice and the identifier of the tenant.

By determining the corresponding network slice level charging information based on the identifier of the network slice, the network slice level charging information is correlated with the UE level charging information.

Then, based on the indication for the at least one parameter related to the network slice level charging information to be acquired in the charging service request 150, the tenant CCS 120 may determine the at least one parameter related to the network slice level charging information in the charging service response 180. For example, in a case where the indication in the charging service request 150 indicates the maximum number of PDU session and/or the number of ongoing PDU session, the tenant CCS 120 may determine the maximum number of PDU session and/or the number of ongoing PDU session as the at least one parameter in the charging service response 180 among the parameters in the NSM charging data and the NSPA charging data of the network slice determined based on the identifier of the network slice.

Additionally, in the operation 170, the tenant CCS 120 may further determine the network slice is allowed or rejected for the UE based on at least one of the identifier of the UE, the identifier of the network slice, or the network slice level charging information.

For example, in a case where the UE requests to establish a PDU session served by a network slice of the tenant CCS 120, and the number of ongoing PDU session has reached the maximum number of PDU session, the tenant CCS 120 may determine the network slice is rejected for the UE.

In the operation 170, in a case where the tenant CCS 120 has determined the network slice is allowed or rejected for the UE, the tenant CCS 120 may determine the charging service response 180 to include information of at least one of: at least one allowed network slice or at least one rejected network slice.

For example, the charging service response 180 may include an identifier of allowed network slice or an identifier of rejected network slice for the UE. Optionally, the charging service response 180 may further include a reason for the rejection by the network slice, for example, the number of ongoing PDU session of the network slice has reached the maximum number of PDU session of the network slice, the number of registered UEs of the network slice has reached the maximum number of UE of the network slice, and the like.

The tenant CCS 120 may transmit the charging service response 180 corresponding the charging service request 150 to the UE CCS 110.

In an operation 190, the UE CCS 110 may determine a charging criterion of the UE based on the received charging service response 180. The charging criterion is for charging the UE with respect to the network slice and may relate to record, account, rating, quota management and other activity for determining tariff.

The charging criterion may be determined differently for different parameters in the charging service response 180. In an embodiment, assuming that the charging criterion is determined with respect to the UE PDU data connectivity and based on the maximum number of UEs and the number of registered UEs, in a case where the maximum number of UEs can be registered on the network slice is e.g. 10,000 and the number of registered UEs within the network slice is e.g. 9,500 the charging criterion may be determined different from the case where the maximum number of UEs can be registered on the network slice is e.g. 500 and the number of registered UEs within the network slice is e.g. 50. The network slice with more registered UEs may consume e.g. more resources than the network slice with less registered UEs, and on the other hand, more registered UEs sharing the resources may reduce the tariff for individual UE.

In an embodiment, assuming that the UE PDU data connectivity is charged based on the volume related to the network slice level charging information, which may be e.g. aggregated PDU sessions volume of the network slice, the charging criterion may be determined differently dependent on the aggregated PDU sessions volume of the network slice. The charging tariff may be determined higher in a case where more UEs have established the PDU sessions and thus the aggregated PDU sessions volume of the network slice is higher, and conversely the charging tariff may be determined lower in a case where less UEs have established the PDU sessions and thus the aggregated PDU sessions volume of the network slice is lower.

The UE CCS 110 may transmit the charging criterion as a response to the request 130 to the consumer network function. Additionally or alternatively, the response to the request 130 may include information of the at least one allowed network slice and/or the at least one rejected network slice and optionally include the rejection reason for rejected network slice.

With the above solution, UE level charging is correlated with network slice level charging, i.e, the UE level charging is determined with consideration of network slice level charging information. Different parameters related to the network slice level charging information may be taken into account and the charging criterion may be determined flexibly and comprehensively. By this charging solution, the network operator may launch more advance charging plans for the UE by reasonably considering the parameters among the NSM charging data, the NSPA charging data and the like of the network slice.

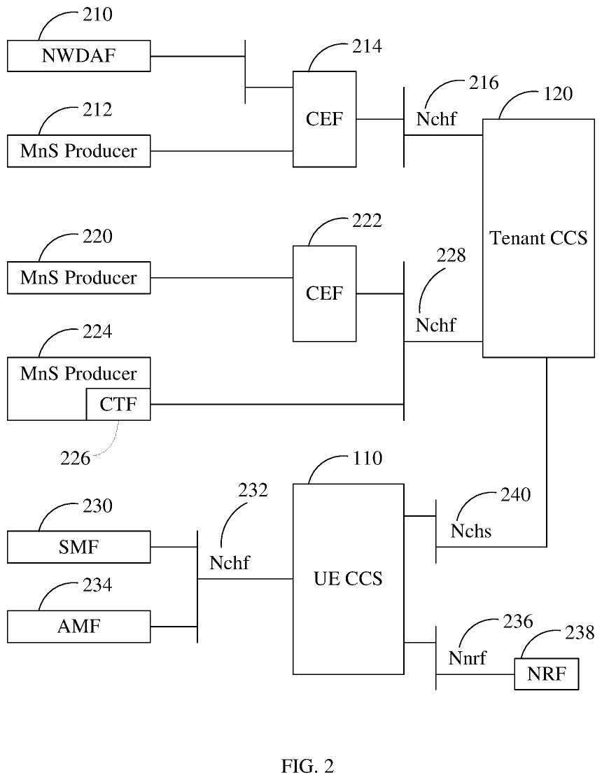

FIG. 2 shows a distributed charging architecture in which example embodiments of the present disclosure can be implemented. Referring to FIG. 2, a charging enablement function (CEF) 214 may receive performance and analytics converged charging information for a network slice from a network data analytics function (NWDAF) 210 and/or a management service (MnS) producer 212, translate the performance and analytics converged charging information for the network slice to the NSPA charging data and transmit the NSPA charging data to the tenant CCS 120 via an interface Nchf 216.

Management converged charging information for the network slice may be collected by a CEF 222 from the MnS producer 220 and/or be collected by a charging trigger function (CTF) 226. The CEF 222 and/or the CTF 226 may translate the management converged charging information for the network slice to the NSM charging data and transmit the NSM charging data to the tenant CCS 120 via an interface Nchf 228.

At least one consumer network function such as the SMF 230, the AMF 234, etc. may transmit e.g. the request 130 for charging the UE to the UE CCS 110 via an interface Nchf 232. Details thereof may refer to the above descriptions with respect to at least the request 130, and repetitive descriptions thereof are omitted here.

The UE CCS 110 may determine the address of the tenant CCS 120 by querying the internal mapping table associating the S-NSSAI identifier with the tenant CCS 120 or by querying via an interface Nnrf 236 a NRF 238 containing the association between the S-NSSAI identifier and the tenant CCS 120. Details of the operation may refer to the above descriptions with respect to at least the operation 140, and repetitive descriptions thereof are omitted here.

The UE CCS 110 may transmit the charging service request 150 to the tenant CCS 120 via an interface Nchs 240, which may be based on hypertext transfer protocol (HTTP) representational state transfer (REST) open application programming interface (API).

The tenant CCS 120 may determine the charging service response 180 based on the charging service request 150 and transmit the charging service response 180 to the UE CCS 110 via the interface Nchs 240, details of which may refer to the above descriptions with respect to at least the charging service request 150, the operation 170, and the charging service response 180, and repetitive descriptions thereof are omitted here.

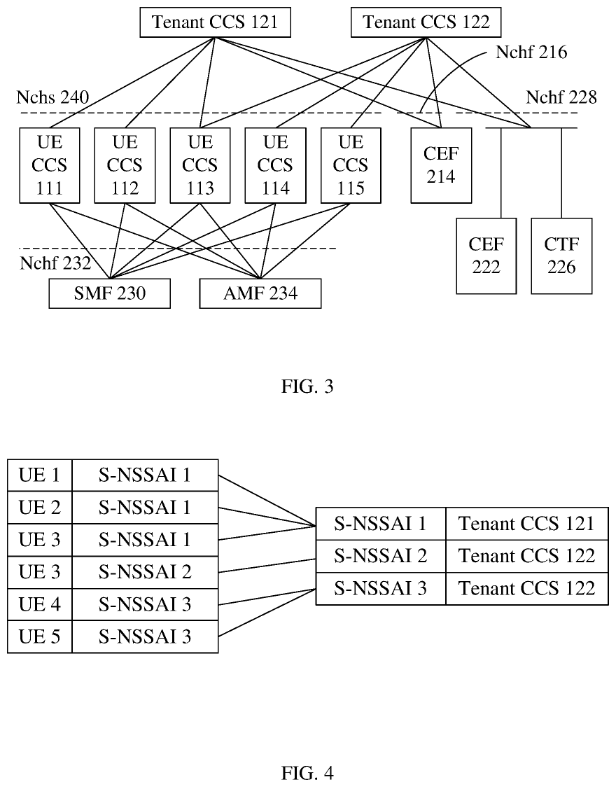

FIG. 3 shows a distributed charging architecture in which example embodiments of the present disclosure can be implemented. Referring to FIG. 3, a UE CCS 111, a UE CCS 112, a UE CCS 113, a UE CCS 114, and a UE CCS 115 may be example instances for the UE CCS 110, and a tenant CCS 121, and a tenant CCS 122 may be example instances for the tenant CCS 120.

FIG. 4 shows a correspondence between network slices and tenant CCSs in the distributed charging architecture depicted by the FIG. 3. In the FIG. 4, a UE 1, a UE 2, a UE 3, a UE 4, and a UE 5 may be served by the UE CCS 111, the UE CCS 112, the UE CCS 113, the UE CCS 114, and the UE CCS 115, respectively.

The SMF 230 and/or the AMF 234 may transmit the request 130 for charging the UE 1, the request 130 for charging the UE 2, the request 130 for charging the UE 3, the request 130 for charging the UE 4, and the request 130 for charging the UE 5 to the UE CCS 111, the UE CCS 112, the UE CCS 113, the UE CCS 114, and the UE CCS 115, respectively, via the interface Nchf 232. The requests 130 for different UEs may be different because, for example, the identifiers of the UEs may be different, the network slices serving the UEs may be different and the indications for the at least one parameter may be different. Details thereof may refer to the above descriptions with respect to at least the request 130, and repetitive descriptions thereof are omitted here.

A UE may subscribe services over more than one network slice instances. For example, the UE 3 may subscribe services used under a network slice 1 and a network slice 2 corresponding to a S-NSSAI 1 and a S-NSSAI 2, respectively.

A network slice instance may serve more than one UEs. For example, the network slice 1 may serve UE 1, UE 2, and UE 3, and network slice 3 may serve UE 4 and UE 5.

The network slice 1 may be owned by a tenant served by e.g. the tenant CCS 121, and the network slice 2 and the network slice 3 may be owned by a tenant served by e.g. the tenant CCS 122.

Based on the S-NSSAI identifiers (identifiers of the network slices) in the respective requests 130, the UE CCS 111, the UE CCS 112, the UE CCS 113, the UE CCS 114, and the UE CCS 115 may discover the addresses of the tenant CCS instances corresponding to the S-NSSAI identifiers. For example, the UE CCS 111, the UE CCS 112, and the UE CCS 113 may determine the tenant CCS 121, and the UE CCS 113, the UE CCS 114, and the UE CCS 115 may determine the tenant CCS 122. The details thereof may refer to the above descriptions with respect to at least the operation 140, and repetitive descriptions thereof are omitted here.

The network slice level charging information may be transmitted to and maintained in the tenant CCS 121 and the tenant CCS 122. For example, the NSPA charging data may be transmitted from the CEF 214 via the interface Nchf 216, and the NSM charging data may be transmitted from the CEF 222 and/or CTF 226 via the interface Nchf 228.

The UE CCS 111, the UE CCS 112, and the UE CCS 113 may transmit the respective charging service requests 150 to the tenant CCS 121 via the interface Nchs 240, and the UE CCS 113, the UE CCS 114, and the UE CCS 115 may transmit the respective charging service requests 150 to the tenant CCS 122 via an interface Nchs 240.

The tenant CCS 121 may determine the respective charging service responses 180 based on the respective charging service requests 140 and transmit the respective charging service responses 180 to the UE CCS 111, the UE CCS 112, and the UE CCS 113, respectively, via the interface Nchs 240. The tenant CCS 122 may determine the respective charging service responses 180 based on the respective charging service requests 150 and transmit the respective charging service responses 180 to the UE CCS 113, the UE CCS 114, and the UE CCS 115 respectively, via the interface Nchs 240.

For the UE CCS 113, the charging service response 180 from the tenant CCS 121 and the charging service response 180 from the tenant CCS 122 may include different parameters because the UE 3 may be charged differently with respect to the network slice 1 and the network slice 2. For example, the charging service response 180 from the tenant CCS 121 may include e.g. the maximum number of PDU and/or the number of ongoing PDU session, and the charging service response 180 from the tenant CCS 122 may include e.g. the maximum number of UE and/or the number of registered UEs.

For the UE CCS 114 and the UE CCS 115, the respective charging service responses 180 from the tenant CCS 122 may be different due to e.g. being rejected or allowed by the network slice 3. For example, the charging service response 180 received by the UE CCS 114 may include e.g. the load level of the network slice 3, and the charging service response 180 received by the UE CCS 115 may include the network slice 3 in the list of rejected network slice with the reason for rejection.

The details may refer to the above descriptions with respect to at least the charging service request 150, the operation 170, and the charging service response 180, and repetitive descriptions thereof are omitted here.

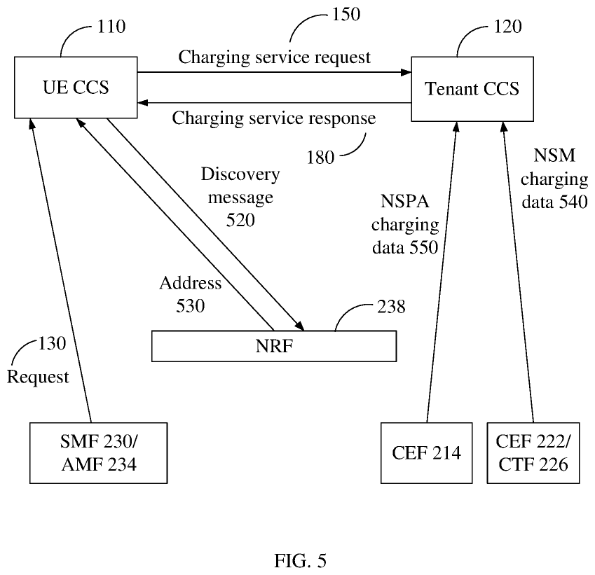

FIG. 5 shows a distributed charging architecture in which example embodiments of the present disclosure can be implemented. Referring to FIG. 5, the SMF 230 and/or the AMF 234 may transmit the request 130 for charging the UE to the UE CCS 110. Based on the S-NSSAI identifier in the request 130, the UE CCS 110 may query the NRF 238 to discover an address 530 of the tenant CCS 120 serving the tenant owning the network slice with the S-NSSAI identifier. For example, the UE CCS 110 may transmit a discovery message 520 to the NRF 238. The discovery message 520 may include search parameters such as source network function indicating the UE CCS 110, the network slice identifier, etc. The NRF may find the address 530 of the tenant CCS 120 based on the network slice identifier and transmit the address 530 to the UE CCS 110. The details thereof may refer to the above descriptions with respect to at least the operation 140 and the FIGS. 3 and 4, and repetitive descriptions thereof are omitted here.

The network slice level charging information may include NSM charging data 540 and/or NSPA charging data 550. The NSM charging data 540 may be transmitted to the tenant CCS 120 from the CEF 222 and/or the CTF 226 and the NSPA charging data 550 may be transmitted to the tenant CCS 120 from the CEF 214.

The UE CCS 110 may transmit the charging service request 150 to the tenant CCS 120 via the interface Nchs 240, and the tenant CCS 120 may determine and transmit the charging service response 180 to the UE CCS 110 via the interface Nchs 240. Details thereof may refer to the above descriptions with respect to at least the charging service request 150, the operation 170, and the charging service response 180, and repetitive descriptions thereof are omitted here.

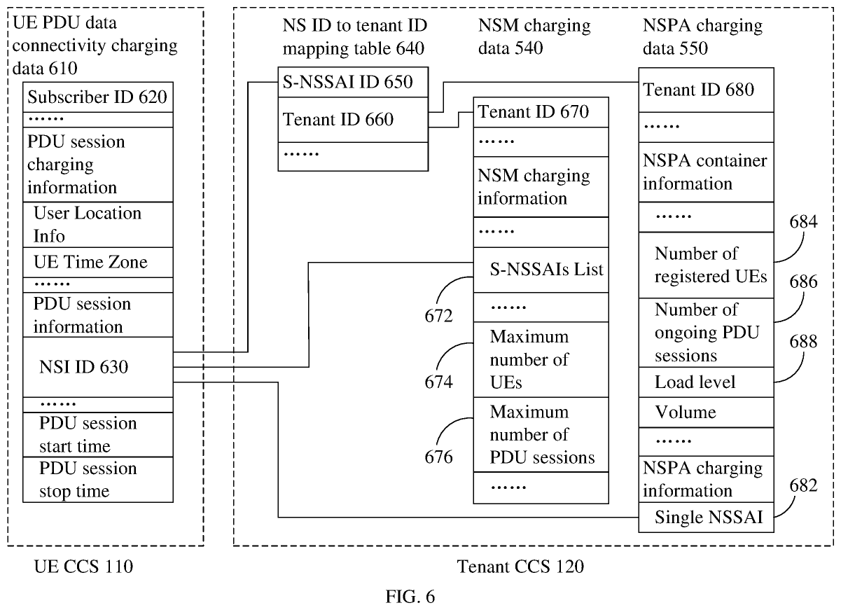

FIG. 6 shows an example of determination of parameters related to network slice level charging information of a network slice according to an embodiment of the present disclosure. Referring to the FIG. 6, UE PDU data connectivity charging data 610 may be an example part of the request 130 received in the US CCS 110 for charging the UE and include a subscriber identifier 620, which may be an example of the identifier of the UE to be charged, a network slice instance (NSI) identifier 630, which may be an example of the identifier of the network slice serving the UE.

The US CCS 110 may determine the tenant CCS 120 based on the NSI identifier 630, details of which may refer to the above descriptions with respect to at least the operation 140 and the FIGS. 3 to 5, and repetitive descriptions thereof are omitted here.

The NSM charging data 540 and the NSPA charging data 550 may be the examples of the network slice level charging information maintained in the tenant CCS 120. Based on the NSI identifier 630 in the charging service request 150, the tenant CCS 120 may determine the NSM charging data 540 with a S-NSSAIs list 672 under NSM charging information and including a S-NSSAI identifier corresponding to the NSI identifier 630. Additionally and alternatively, based on the NSI identifier 630, the tenant CCS 120 may determine the NSPA charging data 550 with a single NSSAI 682 corresponding to the NSI identifier 630 under NSPA charging information.

Additionally and alternatively, the tenant CCS 120 may determine the identifier of the tenant based on an association between the identifier of the network slice and the identifier of the tenant. The identifier of the tenant may be for example a tenant identifier 660, and the identifier of the network slice may be for example a S-NSSAI identifier 650. The association may be maintained in e.g. a mapping table 640 mapping the network slice identifier to the tenant identifier. By finding the S-NSSAI identifier 650 corresponding to the NSI identifier 630, the tenant CCS 120 may determine the tenant identifier 660 mapped by the S-NSSAI identifier 650. The NSM charging data 540 may be determined based on a tenant identifier 670 and the S-NSSAIs list 672 corresponding to the tenant identifier 660 and the NSI identifier 630, respectively. The NSPA charging data 550 may be determined based on a tenant identifier 680 and the single NSSAI 682 corresponding to the tenant identifier 660 and the NSI identifier 630. And thus the network slice level charging information may be correlated with the UE level charging information by determining the corresponding network slice level charging information base on the identifier of the network slice from the request 130 for charging the UE.

Based on the indication for the at least one parameter related to the network slice level charging information, the tenant CCS 120 may determine the charging service response 180 to include the at least one parameter of the NSM charging data 540, such as a maximum number of UEs 674, a maximum number of PDU sessions 676, etc. under the NSM charging information with the S-NSSAIs list 672 and/or of the NSPA charging data 550 such as a number of registered UEs 684, a number of ongoing PDU sessions 686, a load level 688, volume, etc. under NSPA container information corresponding to the NSPA charging information including the Single NSSAI 682. Other details thereof may refer to the above descriptions with respect to at least the operation 170 and the charging service response 180, and repetitive descriptions thereof are omitted here.

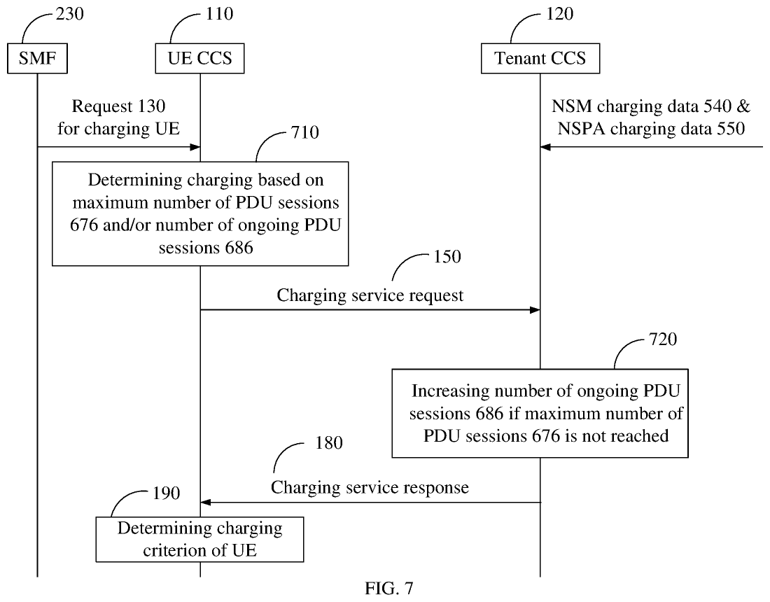

FIG. 7 shows an example flow of charging in a telecommunication network according to an embodiment of the present disclosure. Referring to the FIG. 7, assuming that the SMF 230 receives a PDU session establishment request from a UE, the SMF 230 may transmit the request 130 for charging the UE to the UE CCS 110. Based on the identifier of the network slice in the request 130, the UE CCS 110 may determine the tenant CCS 120 serving the tenant owning the network slice. Details thereof may refer to the above descriptions with respect to at least the request 130 and the operation 140, and the FIGS. 3 to 5, and repetitive descriptions thereof are omitted here.

In an operation 710, the UE CCS 110 may determine charging the UE based on the maximum number of PDU sessions 676 and/or the number of ongoing PDU sessions 686 according to e.g. the charging plan of the UE, and thus the charging service request 150 may include the indication for the maximum number of PDU sessions 676 and/or the number of ongoing PDU sessions 686 as the at least one parameter related to the network slice level charging information of the network slice. Then, the UE CCS 110 may transmit the charging service request 150 to the tenant CCS 120. Other details thereof may refer to the above descriptions with respect to at least the charging service request 150, and repetitive descriptions thereof are omitted here.

The tenant CCS 120 may determine the NSM charging data 540 and the NSPA charging data 550 based on the identifier of the network slice and determine the maximum number of PDU sessions 676 and/or the number of ongoing PDU sessions 686 based on the indication. For example, if the number of ongoing PDU sessions 686 has reached the maximum number of PDU sessions 676, the tenant CCS 120 may determine the network slice is rejected for the UE. Details thereof may refer to the above descriptions with respect to at least the operation 170 and FIG. 6, and repetitive descriptions thereof are omitted here.

The operation 170 may further include an operation 720 if the maximum number of PDU sessions 676 is not reached. In the operation 720, the tenant CCS 120 may increase number of ongoing PDU sessions 686, and thus in the operation 170, the tenant CCS 120 may determine the increased number of ongoing PDU sessions 686 and/or the maximum number of PDU sessions 676 as the at least one parameter related to the network slice level charging information in the charging service response 180.

The tenant CCS 120 may transmit the charging service response 180 to the UE CCS 110, and the UE CCS 110 may determine the charging criterion of the UE based on the charging service response 180 in the operation 190. Details thereof may refer to the above descriptions with respect to at least the operation 190, and repetitive descriptions thereof are omitted here.

The UE CCS 110 may further transmit to the SMF 230 a response to the request 130 based on the charging criterion.

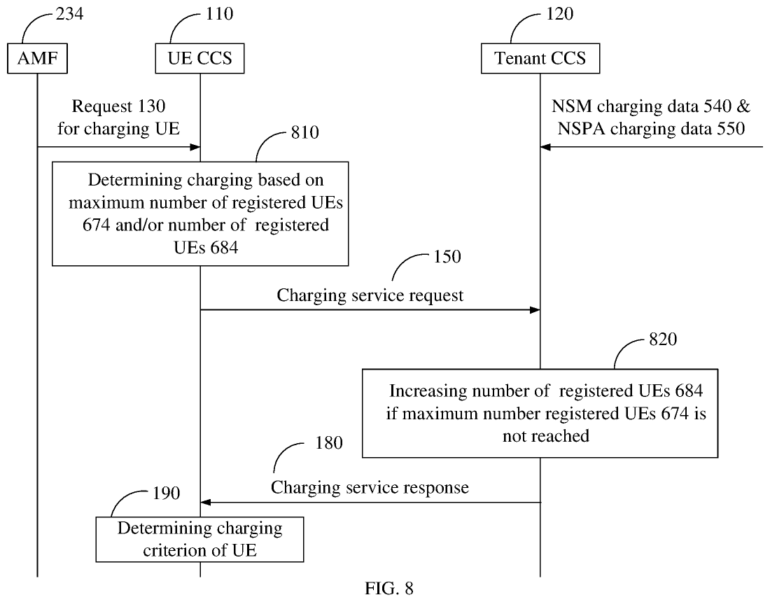

FIG. 8 shows an example flow of charging in a telecommunication network according to an embodiment of the present disclosure. Referring to the FIG. 8, assuming that the AMF 234 receives a registration request from a UE, the AMF 234 may transmit the request 130 for charging the UE to the UE CCS 110. The UE may request to register on more than one e.g. eight network slices and thus the request 130 may include more than one identifiers of the network slices. Based on the identifiers of the network slices in the request 130, the UE CCS 110 may determine the tenant CCS 120 serving the tenants owning the network slices. Details thereof may refer to the above descriptions with respect to at least the request 130 and the operation 140, and the FIGS. 3 to 5, and repetitive descriptions thereof are omitted here.

In an operation 810, the UE CCS 110 may determine charging the UE based on the maximum number of registered UEs 674 and/or the number of registered UEs 684 according to e.g. the charging plan of the UE, and thus the charging service request 150 may, for respective network slices, include the indication for the maximum number of registered UEs 674 and/or the number of registered UEs 684 as the at least one parameter related to the network slice level charging information of the respective network slices. Then, the UE CCS 110 may transmit the charging service request 150 to the tenant CCS 120. Other details thereof may refer to the above descriptions with respect to at least the charging service request 150, and repetitive descriptions thereof are omitted here.

For respective network slices, the tenant CCS 120 may determine whether the network slice is allowed or rejected for the UE. For example, for some network slice, if the service of the network slice is rejected for registration of the UE, the tenant CCS 120 may determine the network slice is rejected for the UE. Further for respective network slices of services allowed for the UE's registration, the tenant CCS 120 may determine the NSM charging data 540 and the NSPA charging data 550 based on the identifier of the network slice and determine the maximum number of registered UEs 674 and/or the number of registered UEs 684 based on the indication. For example, for some network slice if the number of registered UEs 684 has reached the maximum number of registered UEs 674, the tenant CCS 120 may determine the network slice is rejected for the UE. Details thereof may refer to the above descriptions with respect to at least the operation 170 and FIG. 6, and repetitive descriptions thereof are omitted here.

The operation 170 may further include an operation 820 if for some network slice the maximum number of registered UEs 674 is not reached. In the operation 820, the tenant CCS 120 may increase number of registered UEs 684 for that network slice and set that network slice as allowed network slice, and thus in the operation 170, the tenant CCS 120 may determine the increased number of registered UEs 684 and/or the maximum number of registered UEs 674 of that network slice as the at least one parameter related to the network slice level charging information of that network slice in the charging service response 180. The charging service response 180 may optionally include e.g. the identifier of the allowed network slice or the identifier of the rejected network slice.

The tenant CCS 120 may transmit the charging service response 180 to the UE CCS 110, and the UE CCS 110 may determine the charging criterion of the UE for respective network slices based on the charging service response 180 in the operation 190. Details thereof may refer to the above descriptions with respect to at least the operation 190, and repetitive descriptions thereof are omitted here.

The UE CCS 110 may further transmit to the AMF 234 a response to the request 130 based on the charging criterion.

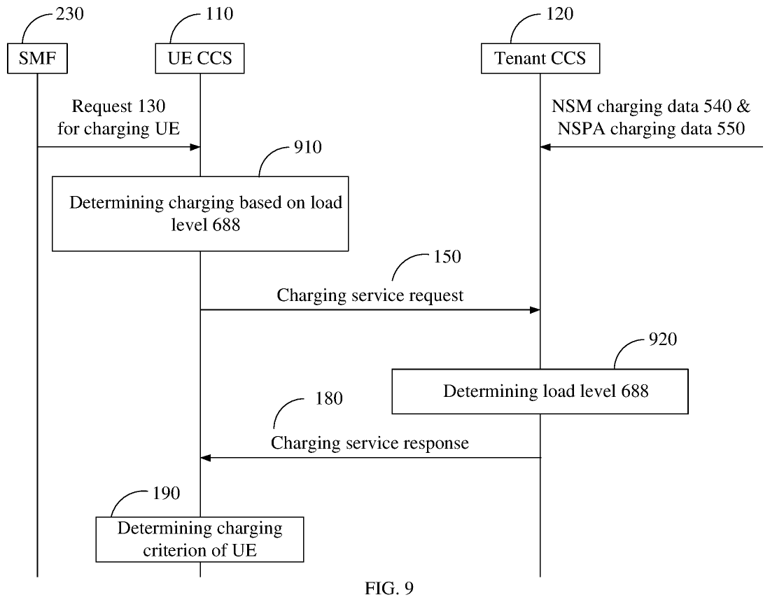

FIG. 9 shows an example flow of charging in a telecommunication network according to an embodiment of the present disclosure. Referring to the FIG. 9, assuming that the SMF 230 receives a PDU session establishment request from a UE, the SMF 230 may transmit the request 130 for charging the UE to the UE CCS 110. Based on the identifier of the network slice in the request 130, the UE CCS 110 may determine the tenant CCS 120 serving the tenant owning the network slice. Details thereof may refer to the above descriptions with respect to at least the request 130 and the operation 140, and the FIGS. 3 to 5, and repetitive descriptions thereof are omitted here.

In an operation 910, the UE CCS 110 may determine charging the UE based on the load level 688 according to e.g. the charging plan of the UE, and thus the charging service request 150 may include the indication for the load level 688 as the at least one parameter related to the network slice level charging information of the network slice. Then, the UE CCS 110 may transmit the charging service request 150 to the tenant CCS 120. Other details thereof may refer to the above descriptions with respect to at least the charging service request 150, and repetitive descriptions thereof are omitted here.

The tenant CCS 120 may determine the NSM charging data 540 and the NSPA charging data 550 based on the identifier of the network slice and in an operation 920 as an example part of the operation 170 determine the load level 688 based on the indication. Details thereof may refer to the above descriptions with respect to at least the operation 170 and FIG. 6, and repetitive descriptions thereof are omitted here.

The tenant CCS 120 may transmit the charging service response 180 to the UE CCS 110, and the UE CCS 110 may determine the charging criterion of the UE based on the charging service response 180 in the operation 190. For example, the charging tariff may be determined higher in a case where more UEs have established the PDU sessions over the network slice and thus the load level 688 of the network slice is higher, and conversely the charging tariff may be determined lower in a case where few UEs have established the PDU sessions and thus the load level 688 of the network slice is lower. Details thereof may refer to the above descriptions with respect to at least the operation 190, and repetitive descriptions thereof are omitted here.

The UE CCS 110 may further transmit to the SMF 230 a response to the request 130 based on the charging criterion.

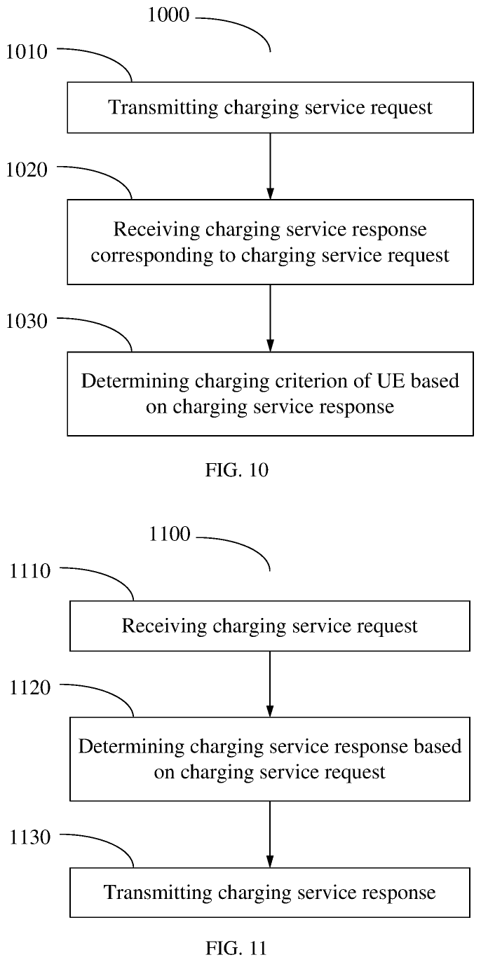

FIG. 10 shows a flow chart illustrating an example method 1000 for charging in a telecommunication network according to an embodiment of the present disclosure. The example method 1000 may be performed for example at a network apparatus related to the UE CCS 110 communicating with a network apparatus related to the tenant CCS 120.

Referring to FIG. 10, the example method 1000 may include an operation 1010 of transmitting, a charging service request from a first network apparatus related to a user equipment converged charging system to a second network apparatus related to a tenant converged charging system, the charging service request comprising an indication for at least one parameter related to network slice level charging information of a network slice, an identifier of the network slice and an identifier of a user equipment; an operation 1020 of receiving, at the first network apparatus, a charging service response corresponding to the charging service request from the second network apparatus, the charging service response comprising the at least one parameter related to the network slice level charging information; and an operation 1030 of determining, by the first network apparatus, a charging criterion of the user equipment based on the received charging service response.

The first network apparatus may be at least a part of the UE CCS 110 or its CHF, and the second network apparatus may be at least a part of the tenant CCS 120 or its CHF. Details of the operation 1010 may refer to the above descriptions with respect to at least the charging service request 150, details of the operation 1020 may refer to the above descriptions with respect to at least the charging service response 180, details of the operation 1030 may refer to the above descriptions with respect to at least the operation 190, and repetitive descriptions thereof are omitted here.

In an embodiment, the example method 1000 may further include an operation of determining the second network apparatus based on the identifier of the network slice received by the first network apparatus in a request for charging the user equipment. The more details may refer to the above descriptions with respect to at least the operation 140, the request 130, and the FIGS. 3 and 4, and repetitive descriptions thereof are omitted here.

In an embodiment, the second network apparatus is determined by querying a network repository function containing an association between the identifier of the network slice and the second network apparatus. The more details may refer to the above descriptions with respect to at least the operation 140 and the NRF 238, and repetitive descriptions thereof are omitted here.

In an embodiment, the at least one parameter related to the network slice level charging information in the charging service response may include at least one of a maximum number of protocol data unit session, a maximum number of user equipment, a number of ongoing protocol data unit session, a number of registered user equipment, a load level, or a volume. The more details may refer to the above descriptions with respect to at least the operation 170, the charging service response 180, the FIG. 6, the operation 720, the operation 820, and the operation 920, and repetitive descriptions thereof are omitted here.

In an embodiment, the charging service response may include information of at least one of: at least one allowed network slice and at least one rejected network slice. The more details may refer to the above descriptions with respect to at least the charging service response 180 and repetitive descriptions thereof are omitted here.

FIG. 11 shows a flow chart illustrating an example method 1100 for charging in a telecommunication network according to an embodiment of the present disclosure. The example method 1100 may be performed for example at a network apparatus related to the tenant CCS 120 communicating with a network apparatus related to the UE CCS 110.

Referring to FIG. 11, the example method 1100 may include an operation 1110 of receiving, at a first network apparatus related to a tenant converged charging system, a charging service request from a second network apparatus related to a user equipment converged charging system, the charging service request comprising an indication for at least one parameter related to network slice level charging information of a network slice, an identifier of the network slice and an identifier of a user equipment; an operation 1120 of determining, at the first network apparatus, a charging service response based on the charging service request, the charging service response comprising the at least one parameter related to the network slice level charging information; and an operation 1130 of transmitting the charging service response from the first network apparatus to the second network apparatus.

The first network apparatus may be at least a part of the tenant CCS 120 or its CHF, and the second network apparatus may be at least a part of the UE CCS 110 or its CHF. Details of the operation 1110 may refer to the above descriptions with respect to at least the charging service request 150, details of the operation 1120 may refer to the above descriptions with respect to at least the operation 170, details of the operation 1130 may refer to the above descriptions with respect to at least the charging service response 180, and repetitive descriptions thereof are omitted here.

In an embodiment, the charging service response may be determined by determining the network slice level charging information based on the identifier of the network slice; and determining the at least one parameter related to the network slice level charging information in the charging service response based on the indication for the at least one parameter related to the network slice level charging information. The more details may refer to the above descriptions with respect to at least the operation 170, the charging service response 180 and FIG. 6, and repetitive descriptions thereof are omitted here.

In an embodiment, the at least one parameter related to the network slice level charging information in the charging service response may include at least one of a maximum number of protocol data unit session, a maximum number of user equipment, a number of ongoing protocol data unit session, a number of registered user equipment, a load level, or a volume. The more details may refer to the above descriptions with respect to at least the operation 170, the charging service response 180, the FIG. 6, the operation 720, the operation 820, and the operation 920, and repetitive descriptions thereof are omitted here.

In an embodiment, the operation 1120 may further include an operation of determining, by the first network apparatus, the network slice is allowed or rejected for the user equipment based on at least one of the identifier of the user equipment, the identifier of the network slice, or the network slice level charging information. The more details may refer to the above descriptions with respect to at least the operation 170, and repetitive descriptions thereof are omitted here.

In an embodiment, the charging service response comprises information of at least one of: at least one allowed network slice or at least one rejected network slice. The more details may refer to the above descriptions with respect to at least the charging service response 180 and repetitive descriptions thereof are omitted here.

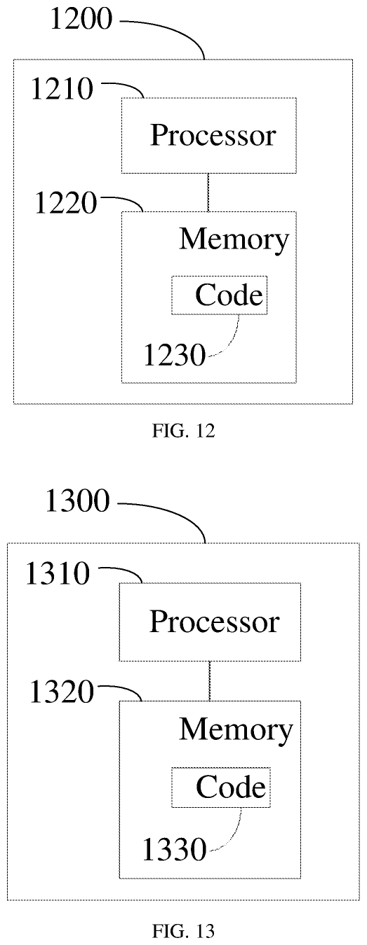

FIG. 12 shows a block diagram illustrating an apparatus for charging in a telecommunication network according to an embodiment of the present disclosure. The apparatus, for example, may be at least part of the UE CCS 110 or its CHF in the above examples.

As shown in FIG. 12, the example apparatus 1200 may include at least one processor 1210 and at least one memory 1220 that may include computer program code 1230. The at least one memory 1220 and the computer program code 1230 may be configured to, with the at least one processor 1210, cause the apparatus 1200 at least to perform the example method 1000 described above.

In various example embodiments, the at least one processor 1210 in the example apparatus 1200 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 1210 may also include at least one other circuitry or element not shown in FIG. 12.

In various example embodiments, the at least one memory 1220 in the example apparatus 1200 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 1220 may include, but are not limited to, an electric, a magnetic, an optical, an electromagnetic, an infrared, or a semiconductor system, apparatus, or device or any combination of the above.

Further, in various example embodiments, the example apparatus 1200 may also include at least one other circuitry, element, and interface, for example at least one I/O interface, at least one antenna element, and the like.

In various example embodiments, the circuitries, parts, elements, and interfaces in the example apparatus 1200, including the at least one processor 1210 and the at least one memory 1220, may be coupled together via any suitable connections including, but not limited to, buses, crossbars, wiring and/or wireless lines, in any suitable ways, for example electrically, magnetically, optically, electromagnetically, and the like.

It is appreciated that the structure of the apparatus on the side of the UE CCS 110 is not limited to the above example apparatus 1200.

FIG. 13 shows a block diagram illustrating an apparatus for charging in a telecommunication network according to an embodiment of the present disclosure. The apparatus, for example, may be at least part of the tenant CCS 120 or its CHF in the above examples.

As shown in FIG. 13, the example apparatus 1300 may include at least one processor 1310 and at least one memory 1320 that may include computer program code 1330. The at least one memory 1320 and the computer program code 1330 may be configured to, with the at least one processor 1310, cause the apparatus 1300 at least to perform at least one of the example method 1100 described above.

In various example embodiments, the at least one processor 1310 in the example apparatus 1300 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 1310 may also include at least one other circuitry or element not shown in FIG. 13.

In various example embodiments, the at least one memory 1320 in the example apparatus 1300 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 1320 may include, but are not limited to, an electric, a magnetic, an optical, an electromagnetic, an infrared, or a semiconductor system, apparatus, or device or any combination of the above.

Further, in various example embodiments, the example apparatus 1300 may also include at least one other circuitry, element, and interface, for example at least one I/O interface, at least one antenna element, and the like.

In various example embodiments, the circuitries, parts, elements, and interfaces in the example apparatus 1300, including the at least one processor 1310 and the at least one memory 1320, may be coupled together via any suitable connections including, but not limited to, buses, crossbars, wiring and/or wireless lines, in any suitable ways, for example electrically, magnetically, optically, electromagnetically, and the like.

It is appreciated that the structure of the apparatus on the side of the tenant CCS 120 is not limited to the above example apparatus 1300.

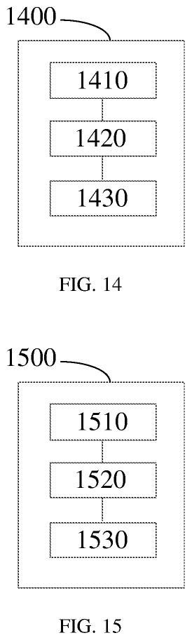

FIG. 14 shows a block diagram illustrating an apparatus for charging in a telecommunication network according to an embodiment of the present disclosure. The apparatus, for example, may be at least part of the UE CCS 110 or its CHF in the above examples.

As shown in FIG. 14, the example apparatus 1400 may include means 1410 for performing the operation 1010 of the example method 1000, means 1420 for performing the operation 1020 of the example method 1000, and means 1430 for performing the operation 1030 of the example method 1000. In one or more another example embodiments, at least one I/O interface, at least one antenna element, and the like may also be included in the example apparatus 1400.

In some example embodiments, examples of means in the example apparatus 1400 may include circuitries. For example, an example of means 1410 may include a circuitry configured to perform the operation 1010 of the example method 1000, an example of means 1420 may include a circuitry configured to perform the operation 1020 of the example method 1000, and an example of means 1430 may include a circuitry configured to perform the operation 1030 of the example method 1000. In some example embodiments, examples of means may also include software modules and any other suitable function entities.

FIG. 15 shows a block diagram illustrating an apparatus for charging in a telecommunication network according to an embodiment of the present disclosure. The apparatus, for example, may be at least part of the tenant CCS 120 or its CHF in the above examples.

As shown in FIG. 15, the example apparatus 1500 may include means 1510 for performing the operation 1110 of the example method 1100, means 1520 for performing the operation 1120 of the example method 1100, and means 1530 for performing the operation 1130 of the example method 1100. In one or more another example embodiments, at least one I/O interface, at least one antenna element, and the like may also be included in the example apparatus 1500.

In some example embodiments, examples of means in the example apparatus 1500 may include circuitries. For example, an example of means 1510 may include a circuitry configured to perform the operation 1110 of the example method 1100, an example of means 1520 may include a circuitry configured to perform the operation 1120 of the example method 1100, and an example of means 1530 may include a circuitry configured to perform the operation 1130 of the example method 1100. In some example embodiments, examples of means may also include software modules and any other suitable function entities.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and acts of the some embodiments described above can be combined to provide further embodiments. The accompanying claims and their equivalents are intended to cover such forms or modifications as would fall within the scope and spirit of the disclosure.

1. A method comprising:
transmitting a charging service request from a first network apparatus related to a user equipment converged charging system to a second network apparatus related to a tenant converged charging system, the charging service request comprising an indication for at least one parameter related to network slice level charging information of a network slice, an identifier of the network slice and an identifier of a user equipment;
receiving, at the first network apparatus, a charging service response corresponding to the charging service request from the second network apparatus, the charging service response comprising the at least one parameter related to the network slice level charging information; and
determining, by the first network apparatus, a charging criterion of the user equipment based on the received charging service response.

2. The method of claim 1, further comprising:
determining the second network apparatus based on the identifier of the network slice received by the first network apparatus in a request for charging the user equipment.

3. The method of claim 2, wherein the second network apparatus is determined by querying a network repository function containing an association between the identifier of the network slice and the second network apparatus.

4. The method of claim 1, wherein the at least one parameter related to the network slice level charging information in the charging service response comprises at least one of a maximum number of protocol data unit session, a maximum number of user equipment, a number of ongoing protocol data unit session, a number of registered user equipment, a load level, or a volume.

5. The method of claim 1, wherein the charging service response comprises information of at least one of: at least one allowed network slice and at least one rejected network slice.

6. A method comprising:
receiving, at a first network apparatus related to a tenant converged charging system, a charging service request from a second network apparatus related to a user equipment converged charging system, the charging service request comprising an indication for at least one parameter related to network slice level charging information of a network slice, an identifier of the network slice and an identifier of a user equipment;
determining, at the first network apparatus, a charging service response based on the charging service request, the charging service response comprising the at least one parameter related to the network slice level charging information; and
transmitting the charging service response from the first network apparatus to the second network apparatus.

7. The method of claim 6, wherein the charging service response is determined by
determining the network slice level charging information based on the identifier of the network slice; and
determining the at least one parameter related to the network slice level charging information in the charging service response based on the indication for the at least one parameter related to the network slice level charging information.

8. The method of claim 6, wherein the at least one parameter related to the network slice level charging information in the charging service response comprises at least one of a maximum number of protocol data unit session, a maximum number of user equipment, a number of ongoing protocol data unit session, a number of registered user equipment, a load level, or a volume.

9. The method of claim 6, the determining the charging service response further comprising:
determining, by the first network apparatus, the network slice is allowed or rejected for the user equipment based on at least one of the identifier of the user equipment, the identifier of the network slice, or the network slice level charging information.

10. The method of claim 9, wherein the charging service response comprises information of at least one of: at least one allowed network slice or at least one rejected network slice.

11. An apparatus comprising:
at least one processor; and
at least one memory comprising computer program code, the at least one memory and the computer program code being configured to, with the at least one processor, cause the apparatus as a first network apparatus related to a user equipment converged charging system to perform:
transmitting a charging service request to a second network apparatus related to a tenant converged charging system, the charging service request comprising an indication for at least one parameter related to network slice level charging information of a network slice, an identifier of the network slice and an identifier of a user equipment;
receiving a charging service response corresponding to the charging service request from the second network apparatus, the charging service response comprising the at least one parameter related to the network slice level charging information; and
determining a charging criterion of the user equipment based on the received charging service response.

12. The apparatus of claim 11, wherein the at least one memory and the computer program code are further configured to, with the at least one processor, cause the apparatus to further perform:
determining the second network apparatus based on the identifier of the network slice received in a request for charging the user equipment.

13. The apparatus of claim 12, wherein the second network apparatus is determined by querying a network repository function containing an association between the identifier of the network slice and the second network apparatus.

14. The apparatus of claim 11, wherein the at least one parameter related to the network slice level charging information in the charging service response comprises at least one of a maximum number of protocol data unit session, a maximum number of user equipment, a number of ongoing protocol data unit session, a number of registered user equipment, a load level, or a volume.

15. The apparatus of claim 11, wherein the charging service response comprises information of at least one of: at least one allowed network slice and at least one rejected network slice.

16. An apparatus comprising:
at least one processor; and
at least one memory comprising computer program code, the at least one memory and the computer program code being configured to, with the at least one processor, cause the apparatus as a first network apparatus related to a tenant converged charging system to perform:
receiving a charging service request from a second network apparatus related to a user equipment converged charging system, the charging service request comprising an indication for at least one parameter related to network slice level charging information of a network slice, an identifier of the network slice and an identifier of a user equipment;
determining a charging service response based on the charging service request, the charging service response comprising the at least one parameter related to the network slice level charging information; and
transmitting the charging service response to the second network apparatus.

17. The apparatus of claim 16, wherein the charging service response is determined by
determining the network slice level charging information based on the identifier of the network slice; and
determining the at least one parameter related to the network slice level charging information in the charging service response based on the indication for the at least one parameter related to the network slice level charging information.

18. The apparatus of claim 16, wherein the at least one parameter related to the network slice level charging information in the charging service response comprises at least one of a maximum number of protocol data unit session, a maximum number of user equipment, a number of ongoing protocol data unit session, a number of registered user equipment, a load level, or a volume.

19. The apparatus of claim 16, wherein the determining the charging service response further comprises:
determining the network slice is allowed or rejected for the user equipment based on at least one of the identifier of the user equipment, the identifier of the network slice, or the network slice level charging information.

20. The apparatus of claim 19, wherein the charging service response comprises information of at least one of: at least one allowed network slice or at least one rejected network slice.

21. (canceled)

22. (canceled)

23. A non-transitory computer readable medium comprising program instructions for causing an apparatus as a first network apparatus related to a user equipment converged charging system to perform:
transmitting a charging service request to a second network apparatus related to a tenant converged charging system, the charging service request comprising an indication for at least one parameter related to network slice level charging information of a network slice, an identifier of the network slice and an identifier of a user equipment;
receiving a charging service response corresponding to the charging service request from the second network apparatus, the charging service response comprising the at least one parameter related to the network slice level charging information; and
determining a charging criterion of the user equipment based on the received charging service response.

24. A non-transitory computer readable medium comprising program instructions for causing an apparatus as a first network apparatus related to a tenant converged charging system to perform:
receiving a charging service request from a second network apparatus related to a user equipment converged charging system, the charging service request comprising an indication for at least one parameter related to network slice level charging information of a network slice, an identifier of the network slice and an identifier of a user equipment;
determining a charging service response based on the charging service request, the charging service response comprising the at least one parameter related to the network slice level charging information; and
transmitting the charging service response to the second network apparatus.
